(19) United States
(12) Patent Application Publication
(10) Pub. No.: US 2017/0291188 A1
(43) Pub. Date: Oct. 12, 2017

(54) TRANSPORTABLE BODY FOR PAINT SPRAYING

(71) Applicant: Caravan Fix Australia Pty Ltd, Queensland (AU)

(72) Inventors: Adam Blackwell, Queensland (AU); Adam Henningsen, Queensland (AU); Reginald Tabone, Queensland (AU)

(73) Assignee: Caravan Fix Australia Pty Ltd

(21) Appl. No.: 15/441,414

(22) Filed: Feb. 24, 2017

(30) Foreign Application Priority Data
Apr. 8, 2016 (AU) 2016100382

(51) Int. Cl. B05B 15/12

(52) U.S. Cl. CPC B05B 15/1296; B05B 15/1222

(57) ABSTRACT

A transportable body (10) suitable for spraying vehicles comprising a main body having a spray compartment (12) with a floor, a ceiling, opposed side walls (16, 18), and a vehicle entry door (20) an upper air inlet plenum for introducing air through the ceiling and an air exhaust in the floor wherein the air inlet and air exhaust are configured to provide a downdraft ventilation system the opposed side walls of the spray compartment are outwardly moveable from a transport position in which the main body can be loaded onto a transporter and a spray position a utility compartment (14) housing an air inlet handling unit (24) with an air inlet fan for supplying air to the air inlet and an air exhaust handling unit (26) with an air exhaust fan for drawing exhaust air from the air exhaust in the floor, the compartments being arranged end to end and a wall separating the compartments.

### FIELD

The present disclosure relates to a transportable body that is suitable for use as a spray booth for a vehicle.

### BACKGROUND

The present specification will be described with particular reference to spraying motor vehicles. However, it will be appreciated that the disclosed transportable body may be used for the purpose of spraying any suitable object, and no limitation is intended thereby. Motor vehicles can include cars, trucks, motor homes, caravans and vehicle parts. Boats, and parts therefore may also be sprayed within the transportable body as disclosed herein.

Spray booths for spray painting vehicles are well known. Spray booths are essentially a separate room in a work shop that have their own ventilation and filtration system. It is considered essential to conduct spray painting in a well ventilated spray booth so as to isolate hazardous solvents and toxic paint aerosols from the surrounding environment and workers. The worker inside the spray booth is provided with respiration protection.

There are a number of different ventilation systems that are available. The simplest and most economical is known as a cross draft spray booth. The incoming air is drawn in across the full width of the front doors through filters and is exhausted through filters in the rear. This is economical as an upper plenum for inlet air is not required and the system only requires an exhaust fan.

In a cross flow spray booth, the air flow is linear across the painted surface. There are recognised disadvantages with a linear air flow. The linear air flow travels across the full length of booth. This means that any contaminants are more likely to come into contact with the vehicle being sprayed when compared to non-linear air flow systems (discussed below). Further, when the painter is positioned other than in front of the vehicle, they will be standing in the air flow and can expose the painter to the toxic chemicals. Still further overspray can contact the vehicle as it is drawn across the length of the booth. This can cause contamination of the finish.

As a result of these disadvantages, a number of other air flow systems that do not have a linear air flow are available. Each of these other arrangements introduce air through an upper plenum in the roof and require an inlet fan in addition to an exhaust fan.

One such system is known as a semi down draft airflow. The air is introduced through a small section in the ceiling and exhausts through the rear wall. This creates a draft pattern that is directed diagonally across the booth so that the air is not travelling directly across the vehicle. There are still practical disadvantages as the painter is still in the direction of the air flow. There is also a dead zone at the front of the booth that gets les air flow than the rest of the booth.

As a result of the disadvantages of exhausting through the rear, other systems have are used that exhaust through the sides of the booth, side draft, or through the floor, down draft. Both of these systems introduce air across the full length and width of the ceiling, thereby increasing the costs assisted with the required upper plenum to deliver the inflow.

Whilst the side draft system avoids the disadvantages of rear exhaust, there are still some recognized disadvantages such as the painter is still standing in the flow of the overspray as the air is exhausted behind them.

This problem of the side draft is addressed by the down draft spray booth that introduces air through the ceiling and exhausts through the floor. This requires construction of a pit below the floor for the exhaust air flow. Pit construction contributes significantly to the cost of a down draft spray booth. However, there are significant advantages in a downdraft spray booth. As air is drawn around the vehicle and exhausted from underneath there is less distance for the air to travel and less risk of contaminants contacting the finish. Further overspray is pulled downwards and away from both the vehicle and the painter.

Spray booths are built on site and can take up to 6 to 8 weeks to construct. It will be appreciated that this represents a significant work space downtime. Portable spray booths that have inflatable walls are commercially available. However, they are considered unsuitable in terms of worker and environmental safety and are unable to provide an air flow that can provide an acceptable quality of finish.

The present disclosure provides an alternative spray booth that is transportable and is able to provide a downdraft air flow system.

### SUMMARY

The present disclosure relates to a transportable body suitable for spraying vehicles comprising:
a main body having a spray compartment with a floor, a ceiling, opposed side walls, and a vehicle entry door;
an upper air inlet for introducing air through the ceiling and an air exhaust in the floor wherein the air inlet and air exhaust are configured to provide a downdraft ventilation system;
the opposed side walls of the spray compartment are outwardly moveable from a transport position in which the main body can be loaded onto a transporter and a spray position;
a utility compartment housing an air inlet handling unit with an air inlet fan for supplying air to the air inlet and an air exhaust fan for drawing exhaust air from the air exhaust in the floor, the compartments being arranged end to end; and
a wall separating the compartments.

The body can be loaded onto and unloaded from a transporter such as a truck or trailer.

The spray compartment has side walls that can move outwardly from a transport to a spray position. Suitably when the walls are in the transport position, the width of the forward compartment is within standard width for road transport. This means that the body can be transported without having to comply with traffic regulations for transporting oversize loads.

It will be appreciated that if a spray booth was configured to have a width such that it could be transported as a standard size load rather than an oversize load, there would be insufficient room for a painter to work in that space.

Managing air flow in a booth with moveable side walls would be understood by a person of ordinary skill in the art of spray booth design to be problematic.

For example, with a conventional cross flow ventilation system, it is important that the air inlet is across the full width of the front booth. Moveable side walls would create areas of turbulence within the booth. This would adversely affect the movement of overspray through the booth and adversely affect the paint finish.

The same considerations would apply to a semi down draft ventilation system that has a diagonal air flow from the front to the rear of the booth.

On the other hand, the present inventors have surprisingly and unexpectedly discovered that providing moveable side walls in a booth with a downdraft system does not significantly comprise or disrupt air flow. The air inlet and outlet are configured to provide a down draft ventilation system. A downdraft ventilation system is a system as described above in which air is drawn downwards from the ceiling and exhausted through the floor. In such a system there is minimal or negligible linear or diagonal air flow. The known advantages of such a downdraft ventilation system are also discussed above.

The present inventors have discovered that an additional advantage of the down draft system that makes a significant contribution to working of the transportable body is the ability of the body to incorporate movable side walls in the spray compartment, without adversely affecting air flow and subsequently compromising worker safety or paint finish.

However, the requirements of a down draft ventilation system such as providing an air inlet handling unit, an exhaust in the floor and an upper air inlet plenum means that there is additional complexity of construction and weight that is inconsistent with mobility such as for example being mounted on a chassis having a drawbar for towing.

The present inventors have therefore provided body having a spray compartment and a utility compartment housing the air intake and exhaust handling units for a downdraft ventilation system and configured the body for transport on a transporter.

In practice, the exhaust handling unit may be connected to an exhaust flue or ducting for exhausting air away from the body. The exhaust air handling unit may also include an active carbon filtration system. This may allow the exhaust handling unit to operate without exhaust ducting.

Suitably the air intake in the ceiling includes an air diffuser system for evenly dispersing air into the spray areas. Suitably the air diffuser can deliver air at the pressure and/or speed suitable for the drying of waterborne paints.

Lighting is very important in a spray booth to ensure that the painter can obtain the best possible finish. Conventional spray booths use fluorescent lighting. The present transportable body suitably includes LED lights that are more energy efficient, do not require lamp changes or batten installation.

Suitably, the transportable body includes a serial communications protocol that transmits signals or data relating to at least one operational parameter to a remote controller. The at least one parameter can include temperature of one or both compartments, air pressure, air velocity, electrical fault, air quality in the spray zone, humidity, compressed air pressure, whether the doors to the spray compartment are open or shut and/or properly sealed, or any other parameter associated with operation of the transportable body.

### BRIEF DESCRIPTION OF THE DRAWINGS

FIG. 1 is a schematic perspective view of one aspect of a transportable body in which the side walls are in the spray position;

FIG. 2 is a schematic view of the air flow within the transportable body as shown in FIG. 1;

FIG. 3 is a front end view of the body shown in FIG. 1;

FIG. 4 is the view as shown in FIG. 3 in the transport position;

FIG. 5 is a schematic side view showing the air flow within the body as shown in FIG. 1;

FIG. 6 is an end view showing the air flow and

FIG. 7 is a schematic view of the electrical system of the transportable body.

### DETAILED DESCRIPTION

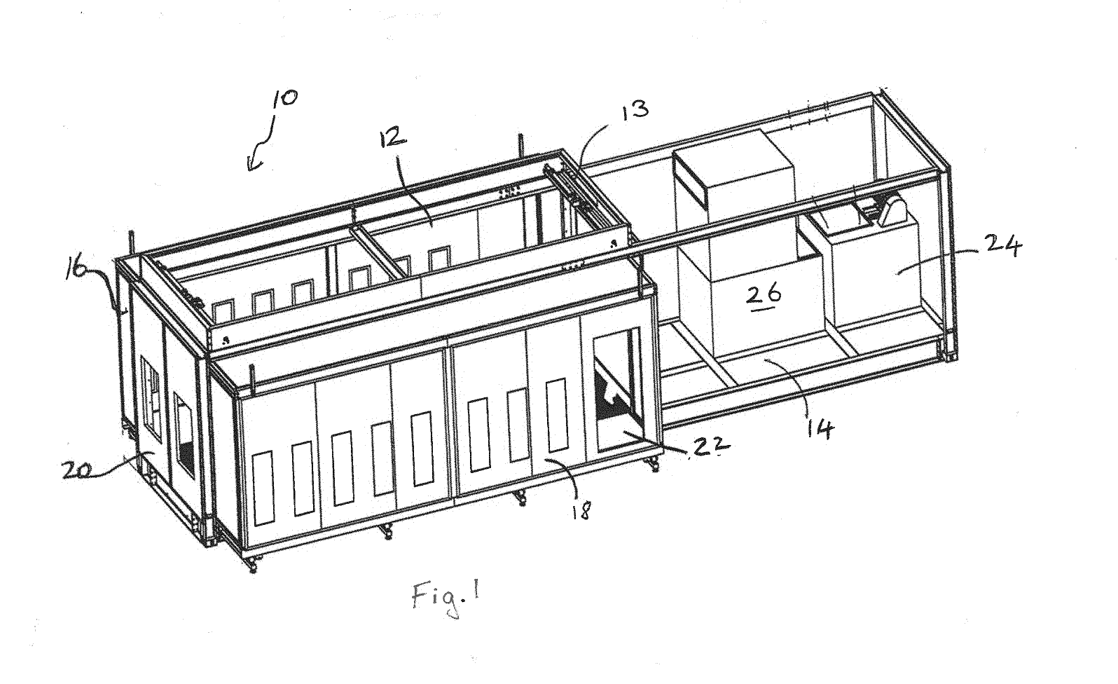

FIG. 1 is a perspective schematic view of one aspect of a transportable body 10 as disclosed herein. The body 10 has a forward spray compartment 12, a rear utility compartment 14 and a wall 13 separating the compartments.

The forward spray compartment 12 has opposed side walls 16, 18 that in FIG. 1 are shown in the open spray position. The forward compartment 12 has a door 20 through which a vehicle can enter and leave the spray compartment. A door way 22 is also provided for a painter to enter and leave the spray compartment 12.

The rear compartment 14 houses an exhaust air handling unit 24. In practice, the exhaust handling unit 24 may be connected to an exhaust flue or ducting for exhausting air away from the body.

The rear utility compartment 12 also houses an air intake handling unit 26.

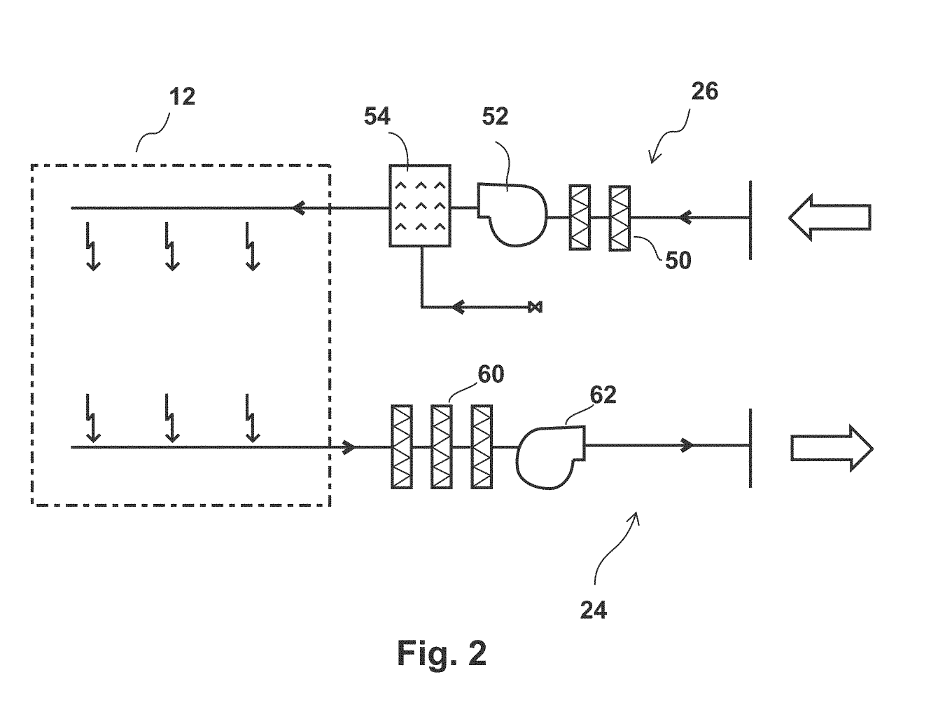

FIG. 2 shows schematically the arrangement of the spray compartment 12 and the air intake handling unit 26 and the air exhaust handling unit 24. The air intake handling unit 24 has a filter bank 50, a supply fan 52 and a gas fired heating system. The gas fired heating system allows for the temperature in the spray compartment to be increased and controlled for paint curing. Gas fired heating of permanently installed spray booths is a known option and gas fired spray booth heating equipment is commercially available.

The exhaust handling unit 24 includes an activated carbon filter bank 60 and an exhaust air fan 62.

The rear utility compartment 14 also includes a compressed air handling unit, a direct gas fired heater system, an electrical operating system and a compressed air unit including the associated regulators for spraying and breathing air.

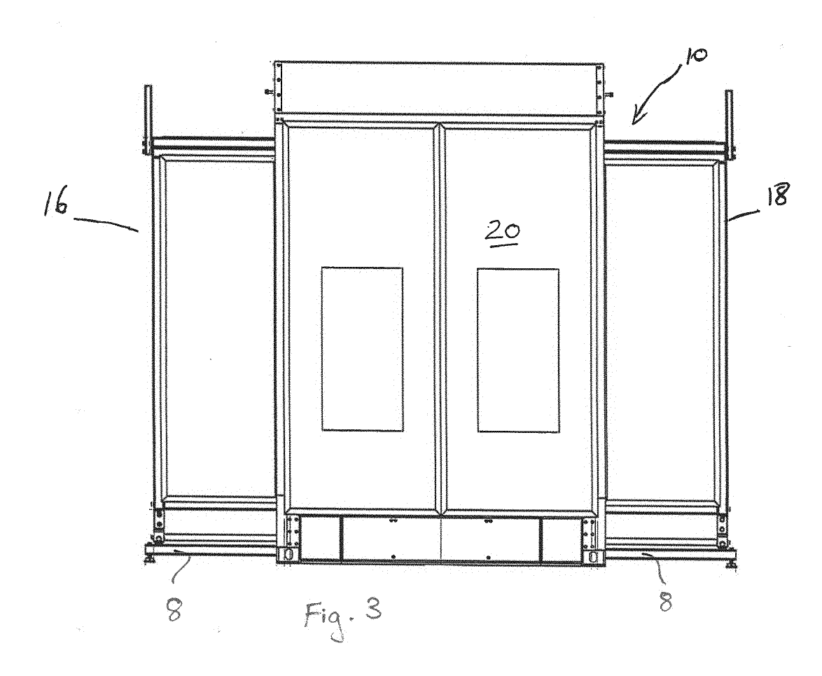

FIG. 3 is an end view of the body 10 showing the extended side walls 16, 18. The area within the extended side walls 16, 18 provides space for a painter to spray paint a vehicle therein.

The body 10 includes four electrically controlled and operated actuators 8 on each wall 16, 18. The actuators extend the walls 16, 18 to accommodate an internal width of 4.2m that is sufficient to allow a painter the space necessary to spray a vehicle. Operation of the actuators is controlled via the electronic control panel in the utility compartment.

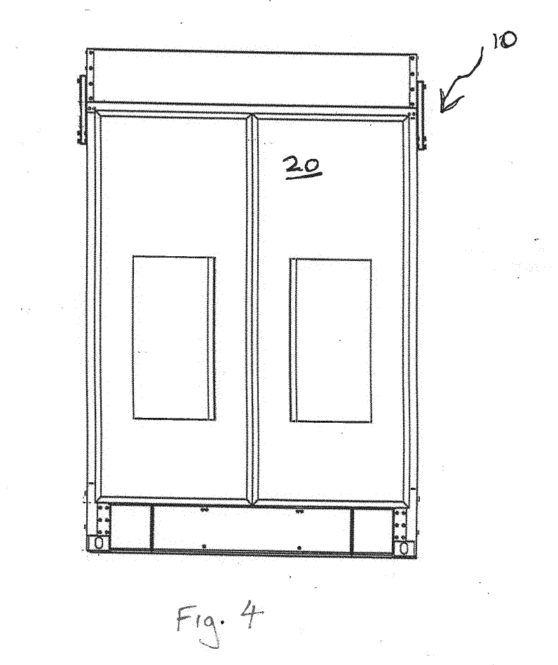

FIG. 4 shows the walls 16, 18 in the transport position. The width of the body in the transport position is suitably that of a conventional shipping container that can be loaded and unloaded onto a conventional transporter such as a truck.

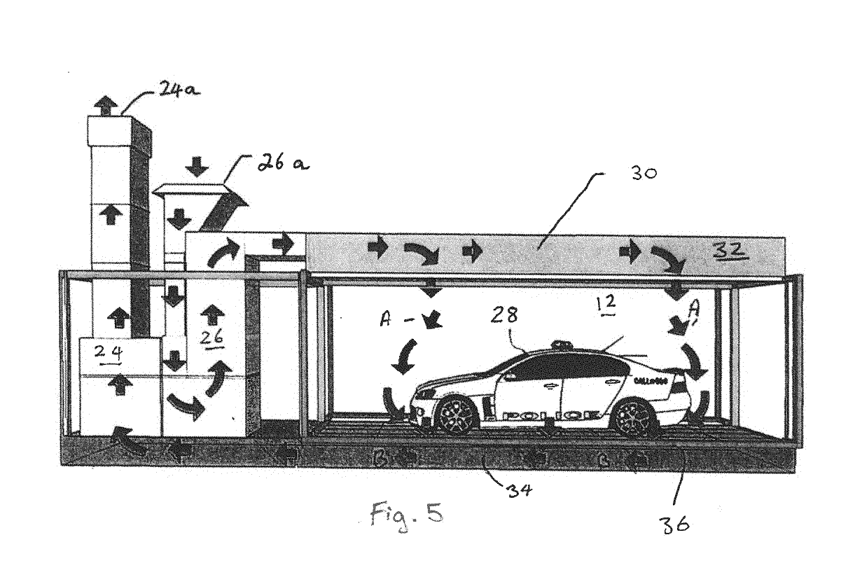

FIG. 5 is a schematic side view of the air flow within the body 10. A vehicle 28 is shown within the forward spray compartment 12. The forward spray compartment 12 has a plenum 30 in the ceiling 32 for inputting air into the spray area in a downwards direction as shown by arrows A. Fresh air intake filters are located in the roof line of the compartment.

The air passes below the vehicle 28 into an exhaust pit 34 in the floor 36 of the forward spray compartment 12. The exhaust air shown be arrows B flows to the exhaust air handling unit 24. In this figures the respective exhaust 24a and intake 26 air ducts are shown. Exhaust filtration is located in the sub-structure of the floor area.

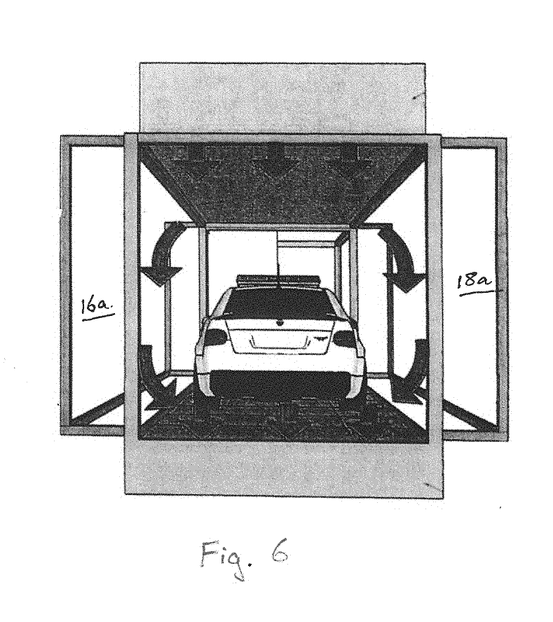

FIG. 6 is an end view showing the down draft air flow. It will be appreciated that the down draft air flow is not interrupted by the air space within the extended wall sections 16a 18a.

In practice, the transportable body is transported to the desired work site and placed on the work site ground surface. The exhaust duct 24a is then erected and if required the exhaust duct 24a is penetrated through the work site roofline and sealed off. The air intake handling unit 26 can either utilise the work site internal air space for induction. Depending upon the quality of the internal air space it may be extended to draw external air through an inlet air duct 26a as a result of the lack of linear or angular air flow experience by ventilation systems other than downdraft ventilation.

The body 10 is then connected to mains electrical power through an electrical control panel that is in the utility compartment 14.

Mains gas supply is then connected to the gas fired heater system that is also located in the utility compartment.

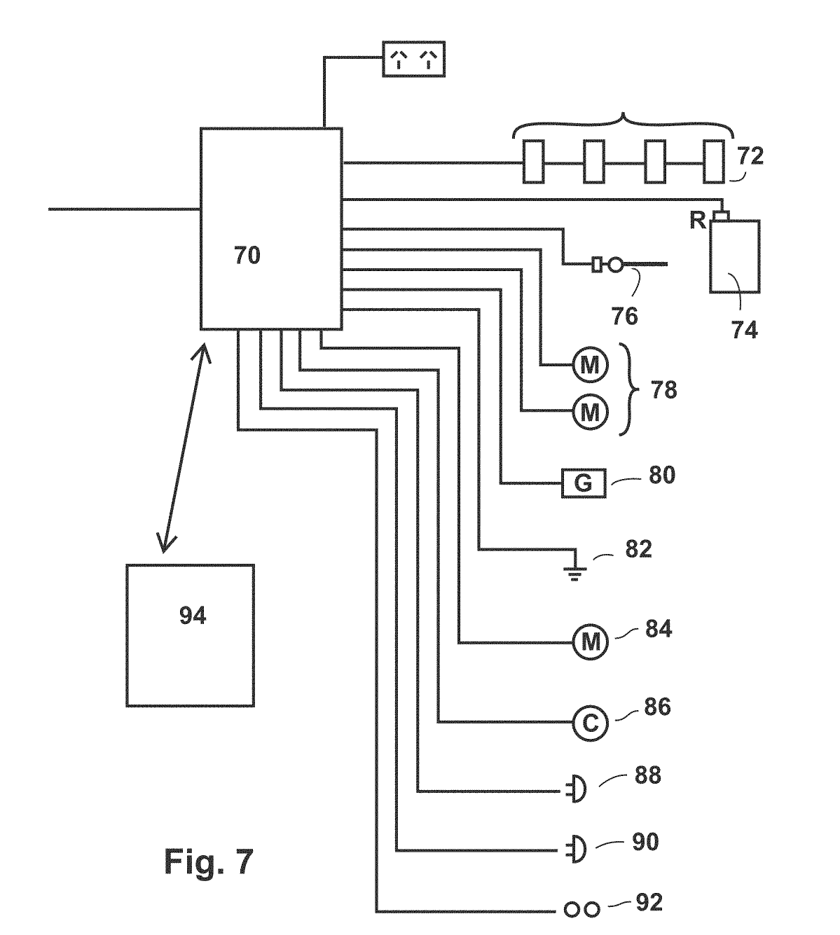

FIG. 7 is a schematic view of the electrical system of the transportable body. The system has an electrical control panel 70 that is electrically connected to the lighting for the spray booth, 72, a door sensor 74 that confirms that the doors to the spray compartment are closed, a spray compartment temperature probe 76 for monitoring the temperature in the spray compartment 12, the ventilation motors 78, the gas heating system 80, equipotential bonding 82, the side wall actuators 84, the air compressor for the spray function 86, spray enable 88 and bake enable controls 90 and indicator lights 92.

After deployment of the services connections, the walls 16, 18 may then be extended outwardly so as to provide the work area for the painter.

The transportable body employs a serial communications protocol, suitably an OEM MODBUS system. The MODBUS system operates the heating function together with a “back to base” interface that alerts a remote controller 94 of any electrical, air, combustion or any other issues with system operation. The remote controller is suitably familiar with the system and can provide the site operator with real time online instructions to attend to general issues that may arise.

It will be appreciated that the presently disclosed transportable body provides many advantages over conventional fixed spray booths. The transportable body can be deployed to a work site and can be operational within a short period of time such as one to three days, compared to 6 to 8 weeks. In some circumstances there may be an unprecedented but temporary increase in vehicle spray painting requirements such as after a heavy storm or the like. In this case, a paint shop can arrange for an additional spray booth(s) to be delivered for a temporary period of time. Should the paint shop change locations, the cost of removing and reinstalling fixed spray booths can be significant.

Importantly, the transportable body of the present invention can supply a full down draft ventilation system. The inventors are unaware of any transportable or mobile spray booth that can offer this function. Down draft ventilation systems are known in the industry to be the best accepted standard in terms of painter safety and quality of finish. The end to end arrangement of the utility and spray compartments allows the body to be mounted on a conventional truck bed transporter.

It will be appreciated that various changes and modifications may be made to the body as disclosed and claimed herein without departing from the spirt and scope thereof.

1. A transportable body suitable for spraying vehicles comprising:
a main body having a spray compartment with a floor, a ceiling, opposed side walls, and a vehicle entry door;
an upper air inlet for introducing air through the ceiling and an air exhaust in the floor, wherein the upper air inlet and the air exhaust are configured to provide a downdraft ventilation system;
the opposed side walls of the spray compartment are outwardly moveable from a transport position in which the main body can be loaded onto a transporter to a spray position;
a utility compartment housing an air inlet handling unit with an air inlet fan for supplying air to the air inlet and an air exhaust handling unit with an air exhaust fan for drawing exhaust air from the air exhaust in the floor, the compartments being arranged end to end; and
a wall separating the compartments.

2. The transportable body of claim 1, wherein the utility compartment further houses a heating system.

3. The transportable body of claim 1, wherein the air exhaust handling unit comprises an active carbon filtration system.

4. The transportable body of claim 1 further comprising telescopic actuators for moving the walls from the transport position to the spray position.

5. The transportable body of claim 1, including a serial communications protocol that transmits signals or data relating to at least one operational parameter to a remote controller.

6. The transportable body of claim 1, wherein the air exhaust handling unit further comprises an exhaust flue.

7. The transportable body of claim 1, wherein the downdraft ventilation system further comprises an air diffuser system.

8. The transportable body of claim 1, wherein the spray compartment further comprises LED lights.

9. The transportable body of claim 1, wherein the utility compartment further comprises a compressed air handling unit.

10. The transportable body of claim 1, wherein the internal width of the transportable body is at least 4.2 meters when the opposed side walls of the spray compartment are in an extended position.
